(19) United States
(12) Patent Application Publication
(10) Pub. No.: US 2006/0147220 A1
(43) Pub. Date: Jul. 6, 2006

(54) Image forming device and jam control method thereof

(75) Inventor: In-sick Seo, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/282,617

(22) Filed: Nov. 21, 2005

(30) Foreign Application Priority Data
Jan. 4, 2005 (KR) 2005-513

(51) Int. Cl. G03G 15/00

(52) U.S. Cl. 399/21

(57) ABSTRACT

The present invention relates to an image forming device comprising a paper feeding part to supply paper loaded in a paper cassette; a printing part to print on the paper supplied by the paper feeding part; and a paper discharging part to discharge the paper printed by the printing part, the image forming device further comprising a jam detector to detect whether the paper is jammed in the paper feeding part, the printing part and the paper discharging part and generate a corresponding signal; and a controller to control the paper feeding part, the printing part and the paper discharging part to stop from operating in response to a jam detecting signal received from the jam detector, and control the paper feeding part to return a standby paper to the paper cassette when the standby paper exists in the paper feeding part. Thus, the present invention provides an image forming device and a jam control method thereof, wherein in a case where paper stands by in a paper feeding part when transferring paper is jammed, the standby paper is automatically returned from the paper feeding part to a paper cassette.

### CROSS-REFERENCE TO RELATED APPLICATIONS

This application claims the benefit of Korean Application No. 2005-513, filed Jan. 4, 2005, in the Korean Intellectual Property Office, the disclosure of which is incorporated herein by reference.

### BACKGROUND OF THE INVENTION

1. Field of the Invention

The present invention relates to an image forming device and a method of controlling a paper jam affecting the image forming device, and, more particularly, to an image forming device and a jam control method thereof, in which jammed paper in a paper feeding part of the apparatus is automatically controlled.

2. Description of the Related Art

As an example of a conventional image forming device, a printer 100 (refer to FIG. 1) comprises a paper feeding part 110 to supply paper 1 that is originally loaded in a paper cassette 101 that is attached to or removably inserted into the printer 100; a printing part 120 to print on a piece of the paper 1 that is supplied by the paper feeding part 110; a paper discharging part 130 to discharge the paper 1 from the printer 100 after the piece of paper 1 is printed on by the printing part 120; and a controller (not shown) to control the paper feeding part 110, the printing part 120 and the paper discharging part 130 to transfer the piece of paper 1 through the printer 100, to print on the piece of paper 1, and to discharge the piece of paper 1 from the printer 100.

Here, the paper 1 loaded in the paper cassette 101 is inserted in the paper feeding part 110 and then transferred to a registration roller 111. When the paper 1 reaches the registration roller 111, the paper 1 is temporarily stopped. After the paper 1 passes the registration roller 111, the printing part 120 prints an image on the paper 1. Then, the printed paper 1 is passed through the printing part 120 and is discharged out of the printer 100 through the paper discharging part 130.

Meanwhile, the conventional printer 100, having the above-described configuration, ends the printing operation when the piece of paper 1 is jammed while being transferred in a printing process. When the piece of paper 1 is jammed, a user opens a cover of the printer 100, draws out the jammed paper 1, and restarts the printer 100. While the printer 100 is restarted, the controller checks whether or not a next piece of paper 1 has been drawn into the paper feeding part 110. Where the next piece of paper 1 is found to have been drawn into the paper feeding part 110, the controller controls the paper 1 to be transferred and discharged out through the paper discharging part 130.

However, in the conventional printer, the next piece of paper 1 having been drawn into the paper feeding part 110 and standing by in the paper feeding part 110 is absolutely discharged through the paper discharging part 130 even though this piece of paper 1 is not used. Therefore, this piece of paper 1 is likely to change in quality because this piece of paper passes through a plurality of rollers. Further, the increased number of times the paper 1 must be reloaded in the paper cassette 101 as a result of occasionally wasting sheets of paper 1 by discharging the sheets through the discharging part 130 even though they may be unused is inconvenient for a user.

### SUMMARY OF THE INVENTION

Accordingly, it is an aspect of the present invention to provide an image forming device and a jam control method thereof, wherein in a case where paper stands by in a paper feeding part when transferring paper is jammed, the standby paper is automatically returned from the paper feeding part to a paper cassette.

Additional aspects and/or advantages of the invention will be set forth in part in the description which follows and, in part, will be obvious from the description, or may be learned by practice of the invention.

The foregoing and/or other aspects of the present invention are achieved by providing an image forming device comprising a paper feeding part to supply paper loaded in a paper cassette; a printing part to print on the paper supplied by the paper feeding part; and a paper discharging part to discharge the paper printed by the printing part, the image forming device further comprising a jam detector to detect whether the paper is jammed in the paper feeding part, the printing part and the paper discharging part and generate a corresponding signal; and a controller to control the paper feeding part, the printing part and the paper discharging part to stop from operating in response to a jam detecting signal received from the jam detector, and control the paper feeding part to return a standby paper to the paper cassette when the standby paper exists in the paper feeding part.

According to an aspect of the present invention, the paper feeding part comprises a transferring roller placed on a transferring path of the paper to transfer the paper, and the controller controls the transferring roller to reversely rotate to return the standby paper from the paper feeding part to the paper cassette.

According to an aspect of the present invention, the paper feeding part further comprises a solenoid to drive the transferring roller, and the controller controls the solenoid to reversely rotate the transferring roller.

The foregoing and/or other aspects of the present invention are achieved by providing a jam control method of an image forming device, comprising stopping a printing process when jammed printing paper is detected; sensing whether standby paper exists in a paper feeding part; and returning the standby paper to a paper cassette in a case where the standby paper exists in the paper feeding part when the printing paper is jammed.

According to an aspect of the present invention, returning the standby paper to the paper cassette comprises reversely rotating a transferring roller that transfers the standby paper.

Additional and/or other aspects and advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a sectional view showing configuration of a conventional printer;

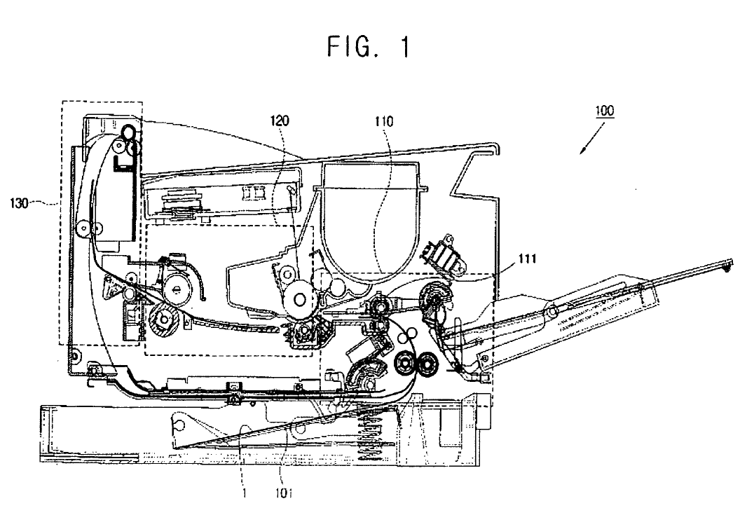

FIG. 2 is a sectional view showing configuration of an image forming device according to an embodiment of the present invention;

FIG. 3 is a block diagram of the image forming device according to an embodiment of the present invention;

FIG. 4 is an enlarged view of a paper feeding part in FIG. 2; and

FIG. 5 is a flowchart illustrating operation of the paper feeding part in FIG. 2.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

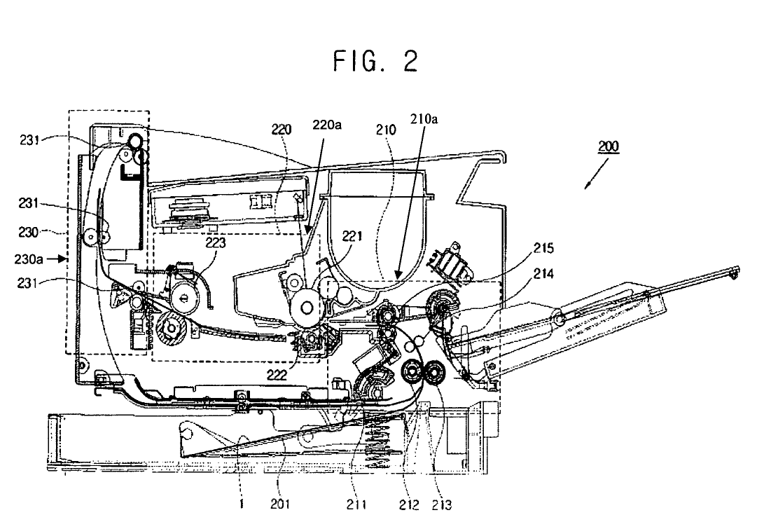

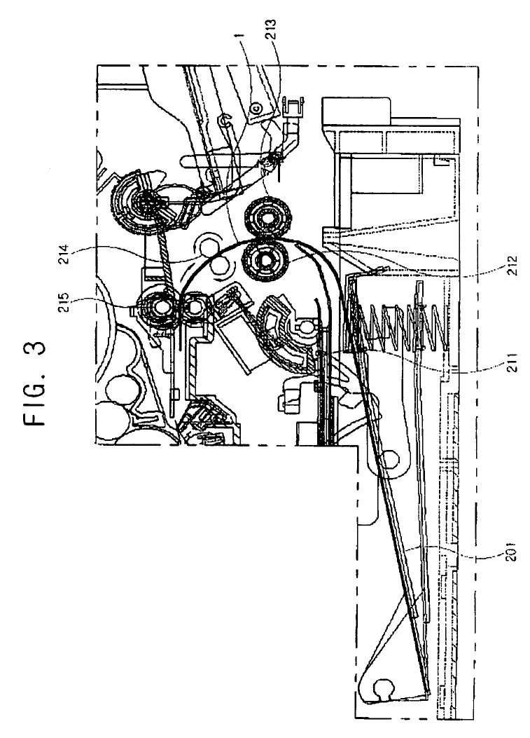

As an example of an image forming device according to an embodiment of the present invention, a printer 200 (refer to FIG. 2) comprises a paper feeding part 210 to supply a piece of paper 1 loaded in a paper cassette 201; a printing part 220 to print on the piece of paper 1 supplied by the paper feeding part 210; a paper discharging part 230 to discharge the piece of paper 1 printed by the printing part 220; and a controller 310 (refer to FIG. 3) to control the paper feeding part 210, the printing part 220 and the paper discharging part 230 to transfer and print out the piece of paper 1.

Here, the piece of paper 1 loaded in the paper cassette 201 is inserted in the paper feeding part 110 by a driving of a pickup roller 211, and is then transferred by a driving of a paper transferring roller 212. In this operation, plural sheets of paper are prevented from being transferred at once by a reversing roller 213 that reversely rotates in contact with the paper transferring roller 212. Then, the paper 1, having passed through the paper transferring roller 212, is transferred by a feed roller 214 and reaches a registration roller 215. Here, a sensor (not shown) senses that the paper 1 reaches the registration roller 215. When the sensor senses that the paper 1 reaches the registration roller 215, the controller 310 controls the piece of paper 1 to be on standby until the piece of paper 1 is transferred to the printing part 220. Thus, the piece of paper 1 standing by in the registration roller 215 is controlled to be transferred to the printing part 220 only after the sensor senses that a previous piece of paper 1 passes through the printing part 220 and the paper discharging part 230.

Then, an organic photo conductor (OPC) drum 221 and a transfer roller 222, which are provided in the printing part 220, form an image on the piece of paper 1 that has passed through the registration roller 215. The image is fused and fixed on the piece of paper 1 by a fusing roller 223. Then, the piece of paper 1 is passed through the printing part 220 and discharged out through the paper discharging part 230 by discharging rollers 231.

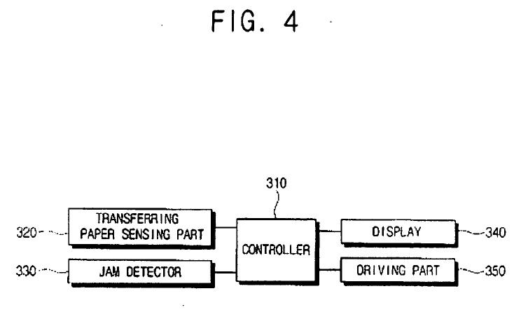

Meanwhile, the paper feeding part 210, the printing part 220, and the paper discharging part 230 are respectively provided with a plurality of sensors 210a, 22a, and 230a. These sensors sense a location of the transferring paper 1. Further, the plurality of rollers are driven in sequence to transfer the piece of paper 1 according to sensing results of the sensor. Also, the plurality of sensors sense a transferring speed of the piece of paper 1 so as to check whether the piece of paper 1 is jammed or not. Referring to FIG. 4, a transferring paper sensing part 320 is connected to the plurality of sensors placed in the respective parts of the printer 200. Therefore, the transferring paper sensor 320 senses the location of the transferring paper, and transmits a sensing signal to the controller 310. Then, the controller 310 controls a driving part 350 based on the sensing signal received from the transferring paper sensing part 320 to drive the paper feeding part 210, the printing part 220, and the paper discharging part 230.

Further, a jam detector 330 is connected to the plurality of sensors placed in the respective parts of the printer 200. Here, the jam detector 330 senses the piece of paper 1 passing between neighboring sensors. Thus, the jam detector 330 calculates the transferring speed of the piece of paper 1 in a corresponding location. The jam detector 330 compares the calculated transferring speed of the paper 1 with a reference speed to determine whether the piece of paper 1 is jammed or not. When the controller 310 receives a jam detecting signal from the jam detector 330, the controller 310 controls the driving part 350 to stop the respective parts of the printer 200, and informs a user of a jammed part through a display 340. Typically, the jammed part is displayed according to locations as “JAM0”, “JAM1” and “JAM2” corresponding to the paper feeding part 210, the printing part 220, and the paper discharging part 230, respectively.

When the piece of paper 1 is jammed in the printing part 220 or the paper discharging part 230, i.e., when “JAM1” or “JAM2” is displayed on the display 340, the transferring paper sensing part 320 checks whether a next piece of paper 1 has been drawn into the paper feeding part 210. In a case where the next piece of paper 1 has been drawn into the paper feeding part 210, the controller 310 controls the driving part 350 to drive the feed roller 214 to rotate in reverse (refer to FIG. 3). Thus, what was going to be the next piece of the paper 1, having been determined to be located in the paper feeding part 210, is returned to the paper cassette 201.

In order to return this piece of paper 1 to the paper cassette 201, the feed roller 214 is rotated in reverse. However, it is understood that there are several ways in which this piece of paper may be returned to the paper cassette 201. Alternatively, another roller placed in the paper feeding part 210 may be rotated in reverse. Further, the plurality of rollers may be rotated in reverse at the same time. Additionally, a driving unit, such as a solenoid, may be provided to drive the respective transferring rollers of the paper feeding part 210, i.e., the paper transferring roller 212, the reversing roller 213, the feed roller 214, the registration roller 215, etc. to rotate forward and in reverse.

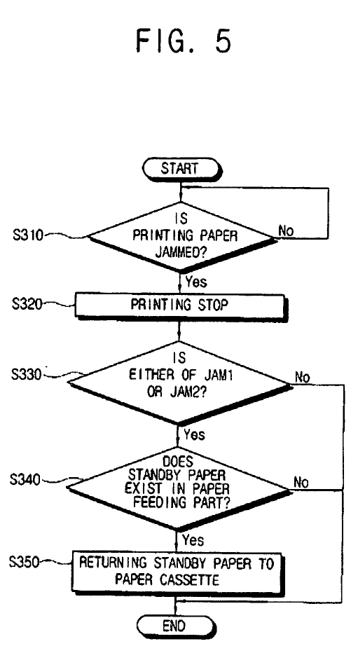

FIG. 5 is a flowchart illustrating operation of the printer 200 when the paper is jammed. At operation S310, the controller 310 determines whether a piece of paper 1 is jammed or not. In the case that the piece of paper 1 is jammed, at operation S320, the controller 310 stops the printing part 220 and the paper discharging part 230 from operating. At operation S330, the controller 310 determines whether a jam in accordance with the “JAM1” or “JAM2,” displays has occurred. In the case of a jam in accordance with the “JAM0,” display, returning the paper 210 to the paper cassette 201 is substantially impossible. Thus, the process in accordance with this embodiment of the invention is stopped. On the other hand, in the case of a jam in accordance with a “JAM1” or “JAM2,” displays, at operation S340, the controller 310 determines again whether a standby or what would have been the next piece of paper 1 on which the printer 200 would have printed has been drawn into the paper feeding part 210. In the case that the standby paper exists in the paper feeding part 210, at operation S350, the controller 310 controls the driving part 350 to cause one or more transferring rollers that are provided in the paper feeding part 210 to rotate in reverse so as to return the standby paper to the paper cassette 201.

As is described above, the present invention provides an image forming device and a jam control method thereof, wherein in a case where standby paper exists in a paper feeding part when transferring paper is jammed, the standby paper is automatically returned from the paper feeding part to the paper cassette, so that it is convenient to reuse the paper.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. An image forming device including a paper feeding part to supply paper loaded in a paper cassette, a printing part to print on the paper supplied by the paper feeding part, and a paper discharging part to discharge the paper printed by the printing part, the device comprising:
a jam detector to detect whether the paper is jammed in one of the paper feeding part, the printing part and the paper discharging part and to generate a corresponding jam detecting signal; and
a controller to control the paper feeding part, the printing part and the paper discharging part to stop operating in response to the jam detecting signal, and to control the paper feeding part to return a standby paper to the paper cassette where the standby paper has been drawn into the paper feeding part.

2. The image forming device according to claim 1, wherein the paper feeding part comprises a transferring roller placed on a transferring path of the paper to transfer the paper, and the controller controls the transferring roller to rotate in reverse so as to return the standby paper from the paper feeding part to the paper cassette.

3. The image forming device according to claim 2, wherein the paper feeding part further comprises a solenoid to drive the transferring roller, and the controller controls the solenoid to rotate the transferring roller in reverse.

4. A method of providing jam control in an image forming device, comprising:
stopping a printing process when jammed printing paper is detected;
sensing whether standby paper has been drawn into a paper feeding part of the device; and
returning the standby paper to a paper cassette where the standby paper is found to have been drawn into the paper feeding part.

5. The jam control method according to claim 4, wherein returning the standby paper to the paper cassette comprises rotating a transferring roller in reverse so as to transfer the standby paper.

6. An image forming apparatus, including a first part to draw paper from a paper cassette into a second part in which a printing operation is commenced, the apparatus comprising:
a jam detector to detect whether a piece of the paper is jammed in the apparatus and to generate a corresponding jam detecting signal; and
a controller to stop the printing operation in response to the jam detecting signal, and to return a standby piece of the paper to the paper cassette in response to the jam detecting signal where the standby paper has been drawn into the first part.

7. The apparatus according to claim 6, wherein the first part comprises a paper feed part to feed paper to the second part.

8. The apparatus according to claim 6, wherein the second part comprises a printing part to print images on the paper.

9. The apparatus according to claim 8, further comprising a paper discharging part to discharge the paper.

10. The apparatus according to claim 6, further comprising a pickup roller which inserts paper into the first part via a driving operation thereof.

11. The apparatus according to claim 9, further comprising:
sensors to sense a location of the piece of paper; and
a plurality of rollers in the first and second parts to feed the piece of paper therethrough, the plurality of rollers being driven in sequence according to sensing results of the sensor.

12. The apparatus according to claim 11, wherein the plurality of sensors sense a transferring speed of the piece of paper so as to check whether the piece of paper is jammed or not.

13. The apparatus according to claim 11, further comprising a transferring paper sensing part, connected to the plurality of sensors, to sense the location of the piece of paper, and to transmit a sensing signal to the controller.

14. The apparatus according to claim 13, wherein the jam detector is connected to the plurality of sensors to sense the piece of paper passing between neighboring sensors.

15. The apparatus according to claim 14, wherein the jam detector calculates a transferring speed of the piece of paper.

16. The apparatus according to claim 15, wherein the jam detector compares the calculated transferring speed of the piece of paper with a reference speed to determine whether the piece of paper is jammed.

17. The apparatus according to claim 16, wherein when the piece of paper is jammed in one of the second and third parts, the transferring paper sensing part checks whether the standby piece of paper has been drawn into the first part.

18. The apparatus according to claim 17, wherein where the standby piece of paper has been drawn into the first part, the controller returns the standby piece of the paper to the paper cassette.

19. The apparatus according to claim 18, wherein the plurality of rollers comprises a feed roller to rotate in reverse so as to returns the standby piece of paper to the paper cassette.

20. A method of operating a printer, including a paper feeding part, during a printing operation when the printer is jammed, comprising:
determining whether a piece of paper, having been drawn into the printer from a paper cassette, is jammed;
if the piece of paper is jammed, stopping the printing operation;
determining whether a standby piece of paper has been drawn into the paper feeding part; and
where the standby paper has been drawn into the paper feeding part, returning the standby piece of paper to the paper cassette.

21. A method of operating a printer, including a paper feeding part, a paper printing part, and a paper discharging part, during a printing operation when the printer is jammed, comprising:
determining whether a piece of paper, having been drawn into the printer from a paper cassette, is jammed in one of the paper printing part and the paper discharging part;
if the piece of paper is jammed in the one of the paper printing part and the paper discharging part, stopping the printing operation;
determining whether a standby piece of paper has been drawn into the paper feeding part; and
where the standby paper has been drawn into the paper feeding part, returning the standby piece of paper to the paper cassette.
